(19) United States
(12) Patent Application Publication
(10) Pub. No.: US 2011/0283708 A1
(43) Pub. Date: Nov. 24, 2011

(54) LANDFILL GAS UTILIZATION

(76) Inventors: RIGO RODRIGUEZ, Avon, IN (US); Mat French, Avon, IN (US); George Hutchins, Avon, IN (US); Steven Gagne, Avon, IN (US)

(21) Appl. No.: 12/786,361

(22) Filed: May 24, 2010

(51) Int. Cl. F02C 3/22

(52) U.S. Cl. 60/772; 60/39.465

(57) ABSTRACT

A method for utilizing landfill gas is disclosed herein. The method includes the step of collecting landfill gas. The method also includes the step of fueling a turbine engine that is at least part of a power generation system with the landfill gas to generate power. The method also includes the step of cooling one or more components of the power generation system with the landfill gas prior to the fueling step. A power generation system capable of practicing the method is also disclosed. A landfill gas utilization system capable of practicing the method is also disclosed.

### BACKGROUND OF THE INVENTION

1. Field of the Invention

The invention relates to a power generation system for deriving power from landfill gas.

2. Description of Related Prior Art

U.S. Pat. No. 6,446,385 discloses a greenhouse system with co-generation power supply, heating and exhaust gas fertilization. A greenhouse is combined with a gas turbine generator set, wherein power, heat and fertilization products are all supplied to the greenhouse by the gas turbine and its exhaust gas in a balanced system for year-round continuous plant production. The system is preferably located at a landfill along with other similar units and is fueled by landfill gas. Excess power from the gas turbine generator in summer months is sold to the electric utility grid as “green power.”

### SUMMARY OF THE INVENTION

In summary, the invention is a method for utilizing landfill gas. The method includes the step of collecting landfill gas. The method also includes the step of fueling a turbine engine that is at least part of a power generation system with the landfill gas to generate power. The method also includes the step of cooling one or more components of the power generation system with the landfill gas prior to the fueling step. A power generation system capable of practicing the method is also disclosed. A landfill gas utilization system capable of practicing the method is also disclosed.

### BRIEF DESCRIPTION OF THE DRAWINGS

Advantages of the present invention will be readily appreciated as the same becomes better understood by reference to the following detailed description when considered in connection with the accompanying drawing wherein:

FIG. 1 is a schematic representation of an embodiment of the invention.

### DETAILED DESCRIPTION OF AN EXEMPLARY EMBODIMENT

The invention, as demonstrated by the exemplary embodiment described below, provides a system for power generation using landfill gas. The system uses the landfill gas as fuel for a turbine engine as well as for cooling. This obviates the requirement for a separate compression system for the fuel of the turbine engine and also the requirement for a cooling system for at least some of the power generation components.

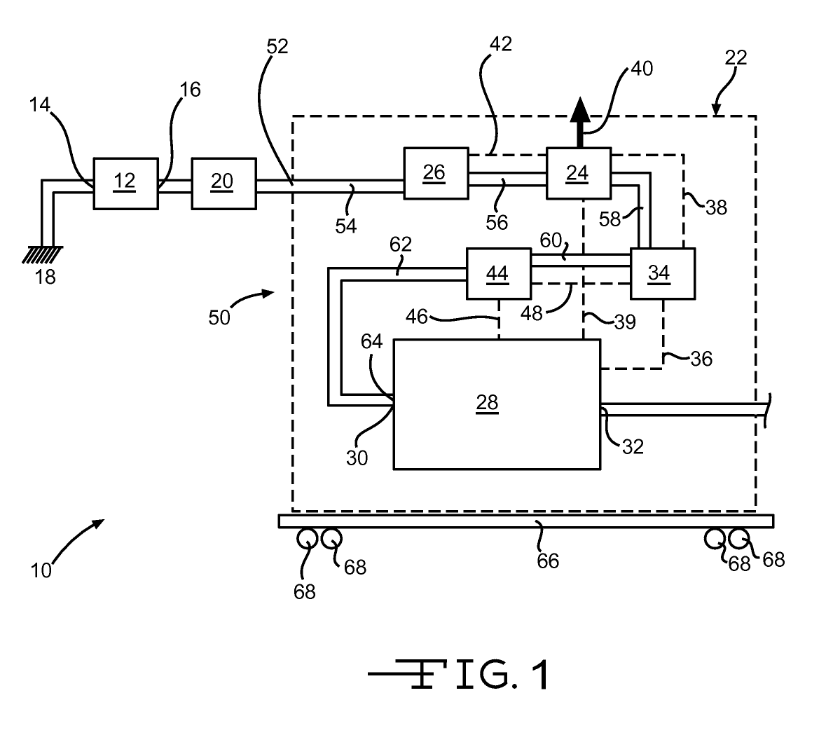

FIG. 1 schematically shows an exemplary landfill gas utilization system 10. The exemplary landfill gas utilization system 10 includes a collection tank 12 operably disposed to collect landfill gas. The collection tank 12 includes a first inlet 14 and a first outlet 16. The collection tank 12 can be disposed at a landfill 18.

The exemplary landfill gas utilization system 10 also includes an air scrubber 20 fluidly connected with the collection tank 12. The air scrubber 20 can be positioned either upstream of the first inlet 14 or downstream of the first outlet 16. The air scrubber 20 can clean the landfill gas upstream of a turbine engine 28.

The exemplary landfill gas utilization system 10 also includes a power generation system 22. In FIG. 1, the exemplary power generation system 22 is substantially surrounded by a box in dash-line. The exemplary power generation system 22 can include a generating device 24 including a rotor. The generating device 24 can generate electricity. The exemplary power generation system 22 can also include electronic circuitry 26 associated with the generating device 24. The electronic circuitry 26 can sense operating conditions of the generating device and control operation of the generating device 24, including the output of electrical power represented by arrow 40. The electrical power represented by arrow 40 can be extracted for any desired purpose. The electrical communication between the generating device 24 and the electrical circuitry 26 is referenced at dash-line 42.

The exemplary power generation system 22 can also include the turbine engine 28 operable to drive the rotor of the generating device 24 in rotation. The turbine engine 28 can include a second inlet 30 and a second outlet 32. The turbine engine 28 can receive fuel or a fuel/air mixture through the second inlet 30, combust the fuel or fuel/air mixture, and direct the combustion gases across rows of static vanes and rotatable blades. The vanes guide the passage of the combustion gases to drive the blades in rotation. The rotation, or kinetic energy, can be applied directly to derive mechanical power or indirectly to derive electrical power. In the exemplary embodiment, the generating device 24 can be a high-speed generator wherein a shaft of the turbine 28 acts as the rotor of the generating device 24. This is represented schematically by dash-line 39. Alternatively, the kinetic energy can be directed through a gearbox 34 to the rotor of the generating device 24. This is represented schematically by dash-line 36. The gearbox 34 can be operably coupled to the generating device 24 to drive the rotor of the generating device 24. This is represented schematically by dash-line 38.

The exemplary power generation system 22 can also include a lubrication distribution system 44. The schematically-shown lubrication distribution system 44 can include a pump and fluid lines to distribute lubricant to various components of the exemplary power generation system 22. The distribution of lubricant to the turbine engine 28 is represented schematically by dash-line 46 and the distribution of lubricant to the gearbox 34 is represented schematically by dash-line 48.

The exemplary power generation system 22 can also include a cooling system 50 disposed downstream of the collection tank 12 and the air scrubber 20. The cooling system 50 is operable to receive cleaned landfill gas from the collection tank 12 or the air scrubber through a third inlet 52. The cooling system 50 extends along a path from the third inlet 52. The exemplary cooling system 50 includes portions 54, 56, 58, 60, 62. The generating device 24 and the electronic circuitry 26 are disposed along the path to be cooled by the landfill gas passing through the cooling system 50.

The electronic circuitry 26 can include a housing that forms part of the cooling system 50. Alternatively, the electronic circuitry 26 can be disposed within a housing that is fully enclosed by, or partially exposed in, the cooling system 50. The cooling system 50 and the electronic circuitry 26 are arranged relative to one another such that the landfill gas passing through the cooling system 50 can extract heat from the electronic circuitry 26.

In the exemplary embodiment of the invention, the landfill gas can extract heat from the electronic circuitry 26 and then pass through portion 56 to the generating device 24. The generating device 24 can include a housing that forms part of the cooling system 50. Alternatively, the generating device 24 can be disposed within a housing that is fully enclosed by, or partially exposed in, the cooling system 50. The cooling system 50 and the generating device 24 are arranged relative to one another such that the landfill gas passing through the cooling system 50 can extract heat from the generating device 24.

In the exemplary embodiment of the invention, the landfill gas can extract heat from the generating device 24 and then pass through portion 58 to the gearbox 34. The gearbox 34 can include a housing that forms part of the cooling system 50. Alternatively, the gearbox 34 can be disposed within a housing that is fully enclosed by, or partially exposed in, the cooling system 50. The cooling system 50 and the gearbox 34 are arranged relative to one another such that the landfill gas passing through the cooling system 50 can extract heat from the gearbox 34.

In the exemplary embodiment of the invention, the landfill gas can extract heat from the gearbox 34 and then pass through portion 60 to the lubrication system 44. The lubrication system 44 can include structures that are fully disposed within the cooling system 50 or are at least partially exposed in the cooling system 50. The cooling system 50 and the lubrication system 44 are arranged relative to one another such that the landfill gas passing through the cooling system 50 can extract heat from the lubrication system 44.

The cooling system 50 extends from the third inlet 52 to a third outlet 64 communicating with the second inlet 30 such that the landfill gas passes from the cooling system 50 and into the turbine engine 28 to be burned as fuel. In the exemplary embodiment, the landfill gas passes from the lubrication system 44 through portion 62 to the second inlet 30. The temperature and pressure of the landfill gas increase as a result of passing through the cooling system 50, the landfill gas extracting heat from the various components of the power generation system 22. The landfill gas thus becomes compressed as the components are cooled.

It is noted that the path of the cooling system can be modified in alternative embodiments of the invention. For example, alternative cooling systems may not be arranged to extract heat from a gearbox and/or a lubrication system. In addition or alternatively, alternative cooling systems may be arranged to extract heat from other components, such as a turbine housing and/or vane mounting structures. Alternative cooling systems may be arranged to cool only one component of a power generation system. It is noted that it may be desirable to apply the landfill gas to cool as many components as possible to (1) enhance the cooling and the life of all the components of the power generation system and (2) maximize the compression of the landfill gas prior to combustion.

In the exemplary cooling system 50, the landfill gas is directed sequentially across a plurality of spaced components of the power generation system 22 prior to being received in the turbine engine 28. For example, the landfill gas first contacts a heat transfer surface associated with the circuitry 26 and then, in order, the generating device 24, the gearbox 34, and the lubrication system 44. The invention is not so limited. In other words, landfill gas can be concurrently directed to a plurality of components for cooling. In sequential embodiments like the exemplary embodiment, the order of components cooled can be selected based on one or more factors or by balancing more than one factor. For example, in one sequential embodiment, the order of the plurality of components to be cooled by the landfill gas can be arranged based on increasing temperatures of the plurality of spaced components (the component that is the coolest being cooled first and the component that is the hottest being cooled last). In another sequential embodiment, the order of the plurality of spaced components receiving the landfill gas can be different than increasing temperatures. For example, the landfill gas can be first directed to a component most vulnerable to damage by overheating. In the exemplary embodiment, the electronic circuitry 26 may be the most vulnerable to damage by overheating and is therefore positioned operably closest to the inlet 52 among the components that are cooled.

As shown in the exemplary embodiment, any type of component may be cooled in various embodiments of the invention. Cooling systems can be applied to cool components having high temperature as a result of the passage of electrical current as well as components having high temperature as a result of mechanical friction. Mechanical friction refers to two or more components moving relative to one other.

In another aspect of the exemplary embodiment, the power generation system 22 can be mobile. The exemplary power generation system 22 can include a platform 66 including wheels 68. The turbine engine 28 and the cooling system 50 can be supported on the platform 66 and thereby operable to move among a plurality of different landfills remotely spaced from one another to selectively generate power from different sources of landfill gas.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. A method comprising the steps of:
collecting landfill gas;
fueling a turbine engine that is at least part of a power generation system with the landfill gas to generate power; and
cooling one or more components of the power generation system with the landfill gas prior to said fueling step.

2. The method of claim 1 further comprising the step of:
compressing the landfill gas concurrent with said cooling step.

3. The method of claim 1 wherein said cooling step is further defined as:
cooling a generating device the power generation system with the landfill gas prior to said fueling step.

4. The method of claim 1 wherein said cooling step is further defined as:
cooling one of a portion of the turbine engine and a gearbox of the power generation system with the landfill gas prior to said fueling step.

5. The method of claim 1 further comprising the step of:
mounting the power generation system on a mobile platform.

6. The method of claim 5 further comprising the step of:
moving the power generation system among a plurality of different landfills remotely spaced from one another to selectively generate power from different sources of landfill gas.

7. The method of claim 1 further comprising the step of:
cleaning the landfill gas prior to said fueling step and subsequent to said collecting step.

8. The method of claim 1 wherein said cooling step is further defined as:
cooling a plurality of the components of the power generation system with the landfill gas prior to said fueling step.

9. The method of claim 8 wherein said cooling step further comprising the step:
directing the landfill gas sequentially across a plurality of spaced components of the power generation system prior to said fueling step.

10. The method of claim 9 wherein said directing step is further defined as:
directing the landfill gas sequentially across the plurality of spaced components of the power generation system wherein the order of the plurality of spaced components receiving the landfill gas is arranged based on increasing temperatures of the plurality of spaced components.

11. The method of claim 9 wherein said directing step is further defined as:
directing the landfill gas sequentially across the plurality of spaced components of the power generation system wherein the order of the plurality of spaced components receiving the landfill gas is different than the order of the plurality of spaced components based on increasing temperatures.

12. The method of claim 1 wherein said cooling step is further defined as:
cooling components having high temperature as a result of the passage of electrical current as well as components having high temperature as a result of mechanical friction.

13. The method of claim 12 wherein said cooling step is further defined as:
cooling the components having high temperature as a result of the passage of electrical current before the components having high temperature as a result of mechanical friction.

14. A power generation system comprising:
a turbine engine fueled by the landfill gas; and
a cooling system operable to apply the landfill gas to cool one or more components of the power generation system prior to fueling the turbine engine.

15. The power generation system of claim 14 further comprising:
a generating device including a rotor driven in rotation by said turbine engine, said cooling system directing the landfill gas to cool said generating device.

16. The power generation system of claim 15 further comprising:
electronic circuitry associated with said generating device, said cooling system directing the landfill gas to cool said electronic circuitry.

17. The power generation system of claim 15 wherein said cooling system extends between an inlet and an outlet and wherein said electronic circuitry is positioned operably closest to said inlet among said one or more components of the power generation system.

18. The power generation system of claim 15 further comprising:
a gear box operably disposed between said generating device and said turbine engine, said cooling system directing the landfill gas to cool said gear box.

19. The power generation system of claim 14 further comprising:
a platform including wheels, wherein said turbine engine and said cooling system are supported on said platform and thereby operable to move among a plurality of different landfills remotely spaced from one another to selectively generate power from different sources of landfill gas.

20. A landfill gas utilization system comprising:
a collection tank operably disposed to collect landfill gas and having a first inlet and a first outlet;
an air scrubber fluidly connected with said collection tank and positioned one of upstream of said first inlet and downstream of said first outlet;
a generating device including a rotor;
electronic circuitry associated with said generating device;
a turbine engine operable to drive said rotor of said generating device in rotation and having a second inlet and a second outlet; and
a cooling system disposed downstream of said collection tank and said air scrubber and operable to receive cleaned landfill gas from one of said collection tank and said air scrubber through a third inlet, said cooling system extending along a path from said third inlet, said generating device and said electronic circuitry disposed along said path to be cooled by said landfill gas passing through said cooling system, said cooling system extending from said third inlet to a third outlet communicating with said second inlet such that the landfill gas passes from said cooling system and into said turbine engine to be burned as fuel.
